(19) United States
(12) Patent Application Publication
(10) Pub. No.: US 2006/0010045 A1
(43) Pub. Date: Jan. 12, 2006

(54) Semiconductor-device order-entry/placement management support system, and server used for the same

(76) Inventors: Kazuya Saito, Yawata (JP); Kunihiro Kawahara, Sakata (JP)

Correspondence Address: HARNESS, DICKEY & PIERCE, P.L.C., P.O. BOX 828, BLOOMFIELD HILLS, MI, 48303, US

(21) Appl. No.: 11/131,612

(22) Filed: May 18, 2005

(30) Foreign Application Priority Data
Jun. 28, 2004 (JP) 2004-189864

(51) Int. Cl. G06Q 30/00

(52) U.S. Cl. 705/26

(57) ABSTRACT

A semiconductor-device order-entry/placement management support system is installed in an affiliated company, and includes: an order-entry/placement management server for receiving an ordering information: process control servers which are installed in subcontract companies A-C, and transmits an invoice information that is prepared based on the manufacturing results in the entrusted manufacturing process; and an order-entry/placement management support server, which is installed in the semiconductor maker, transmits an ordering information to the order-entry/placement management server, and transfers the invoice information received from the process control server to the order-entry/placement management server, and at the same time automatically prepares a document used for controlling the manufacturing of the semiconductor device, based on the ordering information and the invoice information.

### RELATED APPLICATIONS

This application claims priority to Japanese Patent Application No. 2004-189864 filed Jun. 28, 2004 which is hereby expressly incorporated by reference herein in its entirety.

### BACKGROUND

1. Technical Field

The present invention relates to a semiconductor-device order-entry/placement management support system for supporting the management of an order entry/placement to/from a subcontract company and an order-entry/placement management support server used in such a system, in the case where a semiconductor-device manufacturing company manufactures a semiconductor device by entrusting at least a part of the manufacturing processes in a series of manufacturing processes of the semiconductor device to at least one subcontract company.

2. Related Art

In FIG. 4, an example of the conventional manufacturing process of a semiconductor device is shown. In the manufacturing process of a semiconductor device shown in FIG. 4, first in Step S1, with respect to a semiconductor wafer, a front end process (a wafer-processing process), such as an epitaxial growth, a channel formation, and an electrode formation is carried out. Next, in Step S2, with respect to the semiconductor wafer, a bump formation process for forming a bump which serves as a contact for coupling the electrode formed in the front end process with a lead material of a package. Subsequently, in Step S3, a probing-inspection process, in which whether each chip formed in the semiconductor wafer is good or not is inspected using a probe, is carried out.

After the probing-inspection is completed, in Step S4, the semiconductor wafer is divided in a unit of chip, and a back end process (an assembly process), such as a die bonding, a wire bonding, and sealing, are carried out with respect to a good chip. Furthermore, in Step S5, a final test process in which whether the assembled semiconductor device is good or not is inspected finally.

In the semiconductor industry, there are many companies which manage the business by establishing corporations for each of these processes, and a semiconductor maker to which a semiconductor device is ordered from customer companies, such as a set maker, entrusts a part of the manufacturing of a semiconductor device to subcontract companies which takes charge of each process, respectively, and those subcontract companies carry out the manufacturing of the semiconductor device by sharing the roles. In addition, the semiconductor maker to which the semiconductor device is ordered sometimes takes charge of any one of the manufacturing processes.

Conventionally, semiconductor makers manually manage the order entry/placement by exchanging information with each subcontract company by using a mail, or FAX in order to manage the order entry/placement to/from each subcontract company, and therefore there is a problem that it takes time to grasp the information regarding the order entry/placement. Moreover, in the case where a domestic semiconductor maker entrusts a part of the manufacture of a semiconductor device to an overseas subcontract company via an overseas affiliated company, the order entry/placement needs to be managed in both the domestic semiconductor maker and the overseas affiliated company.

Namely, the domestic semiconductor maker sends an ordering information to the overseas affiliated company using a mail or FAX, at the same time receives an invoice information from the affiliated company, and manually prepares a control document based on this information. On the other hand, the overseas affiliated company sends an ordering information to each subcontract company using a mail or FAX, at the same time receives the invoice information sent from each subcontract company, and manually prepares a control document based on this information. In this way, a wasteful effort has been spent by controlling the order entry/placement in the both domestic semiconductor maker and in the overseas affiliated company.

Furthermore, because in a case of a regionally integrated production, wherein locations of a plurality of subcontract companies are within the same country, the manufactured semiconductor device (also including a wafer or a chip) moves directly between the plurality of subcontract companies within the same country, a physical distribution will not be involved in the management of the order entry/placement, and also because the shipping report from the subcontract company is informed to the semiconductor maker via the affiliated company, it is not possible to grasp the situations in a timely manner.

As the related technique, in Japanese Unexamined Patent Publication No. 2002-7852, (FIG. 2, page 1-3), an electronic commerce system and a method thereof suitably applied to the electronic commerce on the Internet are disclosed. According to this electronic commerce system, a product information is transmitted to a general consumer premise's equipment from a product service center using a first telecommunication line such as a satellite broadcasting, collectively, while a product ordering information is transmitted to the product service center from the general consumer premise's equipment using a second communication circuit such as the Internet, and the payment information is returned to the general consumer premise's equipment from the commercial-goods service center. Therefore, it is possible to transmit a large quantity of product information in a high speed, collectively. However, Japanese Unexamined Patent Publication No. 2002-7852, does not disclose regarding an electronic commerce system that is also applicable to the case where a domestic semiconductor maker entrusts a part of the manufacturing of a semiconductor device to an overseas subcontract company via an overseas affiliated company.

Then, in view-of the above-described point, the present invention is intended to provide a semiconductor-device order-entry/placement management support system and an order-entry/placement management support server used in such a system, which enable the order entry/placement to be controlled timely in both the semiconductor maker and the affiliated company, in the case where the domestic semiconductor maker entrusts a part of the manufacturing of a semiconductor device to an overseas subcontract company via an overseas affiliated company.

### SUMMARY

In order to solve the above-described problem, the semiconductor-device order-entry/placement management support system concerning this invention is a semiconductor-device order-entry/placement management support system for supporting the management of an order entry/placement in the case where a semiconductor device is manufactured by entrusting at least a part of the manufacturing processes in the manufacturing of a semiconductor device to at least one third company from a first company via a second company, and includes: an order-entry/placement management server which is installed in the second company and receives an ordering information via a network; a process-control server which is installed in the at least one third company and transmits an invoice information that is prepared based on the manufacturing results in an entrusted manufacturing process via a network; and an order-entry/placement management support server, which is installed in the first company, transmits an ordering information to the order-entry/placement management server via a network, transfers an invoice information received from the process control server to the order-entry/placement management server, and at the same time automatically prepare a document used for controlling the manufacturing of a semiconductor device based on the ordering information and the invoice information.

This semiconductor-device order-entry/placement management support system may further includes a web server which is installed in the first company, automatically receives a document prepared by the order-entry/placement management support server, and publicizes this document to the second company using a web page of the Internet.

In the above semiconductor-device order-entry/placement management support system, it is preferable that the ordering information includes a company name of at least one third company, and an information indicative of a type name and a quantity of a semiconductor device manufactured or inspected in the at least one third company, and that the invoice information includes an information indicative of a company name of the at least one third company, a type name and a lot number of a semiconductor device manufactured or inspected in the at least one third company. Moreover, preferably, the process control server encrypts and transmits the invoice information.

An order-entry/placement management support server concerning this invention is a semiconductor-device order-entry/placement management support system for supporting the management of an order entry/placement in the case where a semiconductor device is manufactured by entrusting at least a part of the manufacturing processes in the manufacturing of a semiconductor device to at least one third company from a first company via a second company, and includes: receiving means to receive an invoice information, which is prepared based on the manufacturing results in a manufacturing process that is entrusted to the at least one third company, from a process control server installed in the at least one third company via a network; transmitting means to transmit an ordering information to an order-entry/placement management server installed in the second company via a network and to transfer an invoice information received by the receiving means to the order-entry/placement management server; and documenting means to automatically prepare a document used for controlling the manufacturing of a semiconductor device based on the ordering information and the invoice information.

Here, the transmitting means may transmit the document prepared by the documenting means to a web server, thereby publicizing this document to the second company using a web page of the Internet. Moreover, the order-entry/placement management support server may further include decrypting means to decrypt the encrypted invoice information which is transmitted from the process control server.

According to this invention, in the case where a first company, which is a semiconductor maker, entrusts a part of the manufacturing of a semiconductor device to a third company, which is an overseas subcontract company, via a second company, which is an overseas affiliated company, an order-entry/placement management support server installed in the semiconductor maker transmits an ordering information to the order-entry/placement management server installed in the affiliated company, and transfers an invoice information received from a process control server installed in the subcontract company to the order-entry/placement management server, and at the same time automatically prepares a document used for controlling the manufacture of a semiconductor device based on the ordering information and the invoice information. Therefore, it is possible to control the order entry/placement timely in the both semiconductor maker and affiliated company.

### BRIEF DESCRIPTION OF THE DRAWINGS

FIG. 1 is a view showing a semiconductor-device order-entry/placement management support system concerning one embodiment of this invention.

FIG. 2 is a block diagram showing a configuration of a semiconductor maker's order-entry/placement management support system.

FIG. 3 is a view showing the contents of an ordering information and an invoice information in the one embodiment of this invention.

FIG. 4 is a view showing an example of the conventional manufacturing process of a semiconductor device.

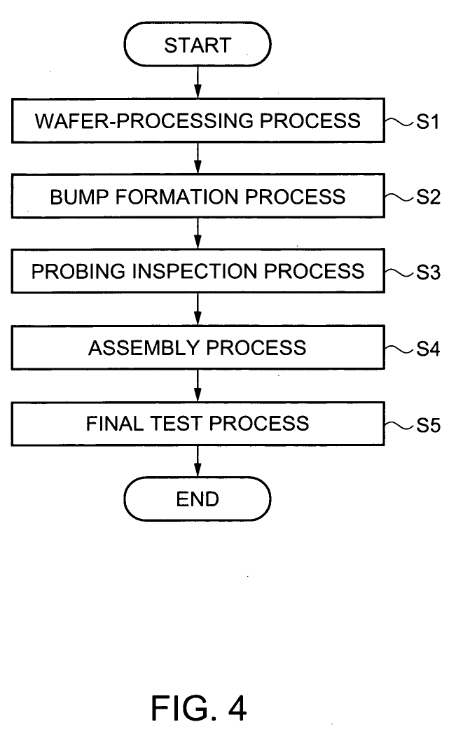

### DETAILED DESCRIPTION

Hereafter, the best mode for carrying out this invention will be described in detail with reference to the accompanying drawings. In addition, like numbers refer to like element, and the description thereof will be omitted.

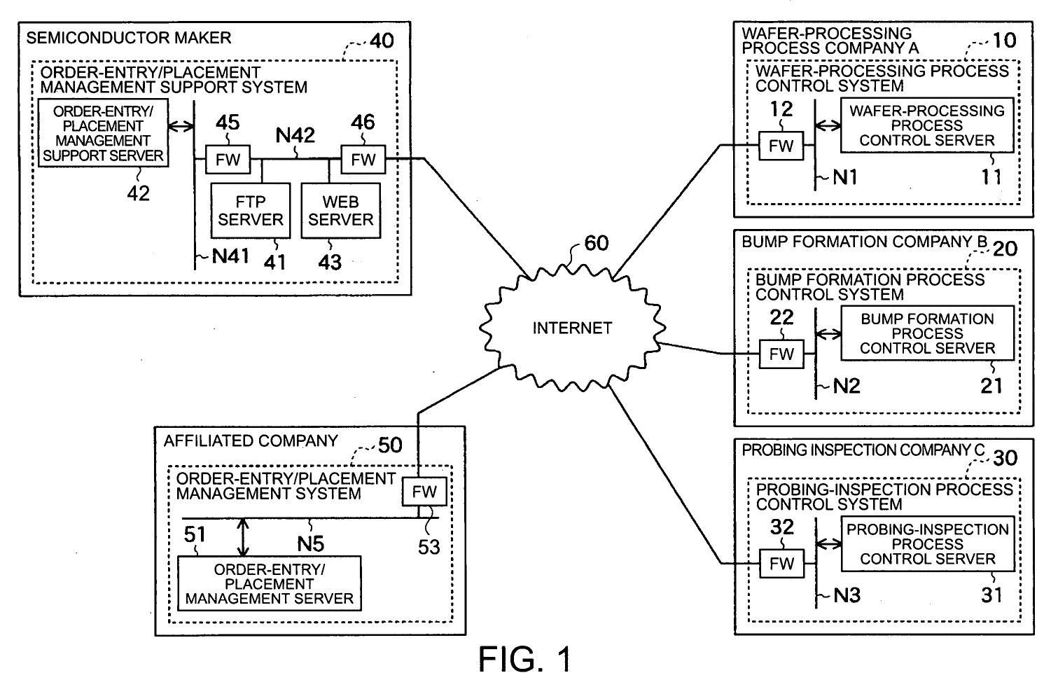

In FIG. 1, the configuration of the semiconductor-device order-entry/placement management support system concerning one embodiment of this invention is shown. In this embodiment, the case where a semiconductor maker in Japan entrusts at least a part of the manufacturing processes in a series of manufacturing processes of a semiconductor device to overseas subcontract companies A-C, via an affiliated company established in overseas will be described.

As shown in FIG. 1, in this semiconductor-device order-entry/placement management support system, a wafer-processing process control system 10 in a wafer-processing process company A which takes charges of a front end process (a wafer-processing process), a bump formation process control system 20 in a bump formation company B which takes charges of a bump formation process, a probing-inspection process control system 30 in a probing-inspection company C which takes charge of a probing-inspection process, a semiconductor maker's order-entry/placement management support system 40, and an order-entry/placement management system 50 in an affiliated company, are mutually connected via Internet 60.

Although, here, an example in which the semiconductor maker entrusts a wafer-processing process, a bump formation process, and a probing-inspection process in a series of manufacturing processes of a semiconductor device, to a subcontract company, will be described. The semiconductor maker may complete the semiconductor device carrying out an assembly process and a final test process at its own company, or may complete the semiconductor device by entrusting those processes to other subcontract companies.

In this embodiment, the semiconductor maker's order-entry/placement management support system 40 provides an ordering information (a purchase order) as the data to the order-entry/placement management system 50 in the affiliated company. Moreover, the wafer-processing process control systems 10, 20, and 30 in the subcontract companies A-C transmit an invoice information as the data at the time of shipping the manufactured lots to the semiconductor maker's order-entry/placement management support system 40, and the order-entry/placement management support system 40 transfers the invoice information to the order-entry/placement management system 50 in the affiliated company. In addition, a “lot” refers to a unit putting together the number of chips that are contained in semiconductor wafers of a predetermined number (for example, 25 wafers).

Furthermore, the semiconductor maker's order-entry/placement management support system 40 automatically prepares a control document which is managed in common use at the semiconductor maker and at the affiliated company, based on the ordering information and the invoice information, and publicizes them to the both parties using a web page or the like of the Internet. This enables a timely order-entry/placement management even if a physical distribution is not involved in managing the order entry/placement, and thereby a prompt action can be taken. Moreover, the control form preparation work can be reduced, and in the semiconductor maker and the affiliated company, the managing based on the same index can be carried out.

With reference to FIG. 1, in the wafer-processing process company A, with respect to a semiconductor wafer, a front end process (a wafer-processing process), such as an epitaxial growth, a channel formation, and an electrode formation is carried out. The wafer-processing process control system 10 in the wafer-processing process company A includes a wafer-processing process control server 11 used for managing the wafer-processing process, and FW (Fire Wall) 12 for preventing unauthorized accesses. Here, the wafer-processing process control server 11 is connected to Internet 60 via a network N1 such as LAN (local area network), and FW12.

The wafer-processing process control server 11 prepares an invoice data indicative of an invoice information containing the company name of the wafer-processing process company A, the type name, the lot number, or the like of the semiconductor device (wafer) of which wafer-processing process is completed, or the like, based on the manufacturing results in the wafer-processing process, and at the same time carries out an encryption processing to the invoice data. The invoice data to which the encryption processing is carried out is transmitted to the semiconductor maker's order-entry/placement management support system 40 in synchronizing with the shipping timing of the lot. Moreover, the semiconductor wafer of which wafer-processing process is completed is shipped to the bump formation company B.

In the bump formation company B, with respect to the semiconductor wafer, a bump formation process for forming a bump, which serves as a contact for coupling the electrode that is formed in the front end process with a lead material of a package, is carried out. The bump formation process control system 20 in the bump formation company B includes a bump formation process control server 21 used for managing the bump formation process, and FW 22 for preventing unauthorized accesses. Here, the bump formation process control server 21 is connected to the Internet 60 via a network N2 such as LAN, and FW 22.

The bump formation process control server 21 prepares an invoice data indicative of an invoice information containing the company name of the bump formation company B, the type name, the lot number, or the like of the semiconductor device (a wafer) of which bump formation process is completed, based on the manufacturing results in the bump formation process, and at the same time carries out an encryption processing to the invoice data. The invoice data to which the encryption processing is carried out by the bump formation process control server 21 is transmitted to the semiconductor maker's order-entry/placement management support system 40 in synchronizing with the shipping timing of the lot. Moreover, the semiconductor wafer of which the bump formation process is completed is shipped to the probing-inspection company C.

In the probing-inspection company C, the probing-inspection, in which whether each chip formed in a semiconductor wafer is good or not is inspected, is carried out. The probing-inspection process control system 30 in the probing-inspection company C includes a probing-inspection process control server 31 used for managing the probing-inspection process, and FW32 for preventing unauthorized accesses. Here, the probing-inspection process control server 31 is connected to the Internet 60 via a network N3 such as LAN, and FW32.

The probing-inspection process control server 31 prepares an invoice data indicative of an invoice information containing the company name of the probing-inspection company C, the type name, the lot number, or the like of the semiconductor device (wafer) of which probing-inspection process is completed, based on the inspection results in the probing-inspection process, and at the same time carries out an encryption processing to the invoice data. The invoice data to which the encryption processing is carried out by the probing-inspection process control server 31 is transmitted to the semiconductor maker's order-entry/placement management support system 40 in synchronizing with the shipping timing of the lot. Moreover, the semiconductor wafer of which the probing-inspection is completed is shipped to the semiconductor maker.

The semiconductor maker's order-entry/placement management support system 40 comprises FTP (file transfer protocol) server 41 used for transferring a file via the Internet 60, an order-entry/placement management support server 42 used for supporting the order-entry/placement management in the manufacturing of a semiconductor device, and a web (WEB) server 43 which prepares a web page, and FW 45 and 46 for preventing unauthorized accesses. Here, the FTP server 41 and the WEB server 43 are connected to the Internet 60 via a network N42 and FW46. Moreover, the order-entry/placement management support server 42 is connected to the network N42 via networks N41 and FW45.

The order-entry/placement management support server 42 transmits an ordering data to the process control servers 11, 21, and 31 of the subcontract companies A-C via the Internet 60 using the FTP server 41. Here, the ordering data indicates the ordering information containing the company name of the subcontract companies A-C, the type name, the quantity, or the like of the semiconductor device which is manufactured or inspected in the subcontract companies A-C.

Moreover, the order-entry/placement management support server 42 receives the invoice data transmitted from the process control servers 11, 21, and 31 of the subcontract companies A-C via the Internet 60, and transfers it to the order-entry/placement management system 50 of the affiliated company by using the FTP server 41. Furthermore, the order-entry/placement management support server 42 automatically prepares a control form, which is a document used for controlling the manufacturing of the semiconductor device, based on the ordering data and the invoice data. The control form prepared in the order-entry/placement management support server 42 is converted into a form of the web page by the WEB server 43.

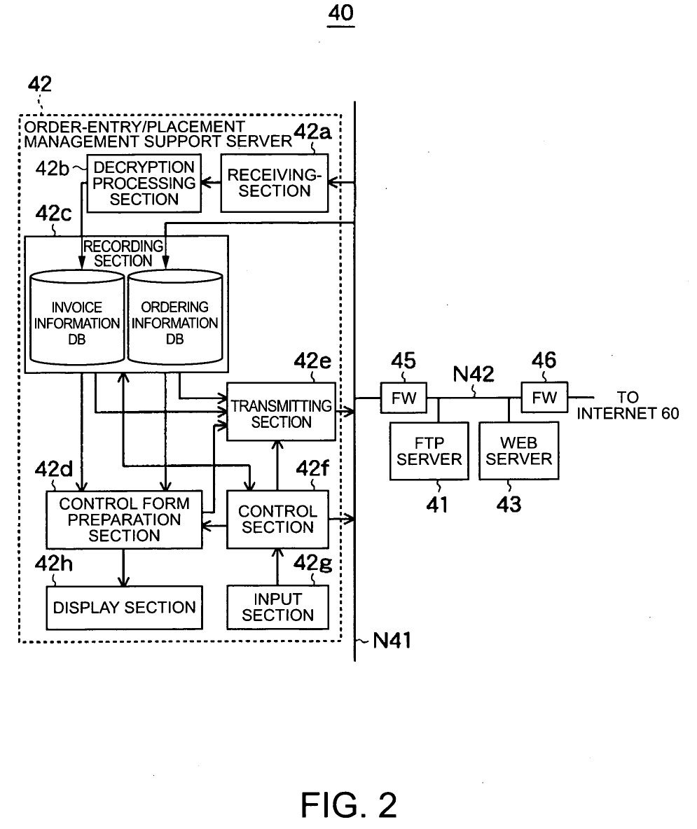

Next, the details of the semiconductor maker's order-entry/placement management support system will be described with reference to FIG. 2. The FTP server 41 receives and records the ordering data or the invoice data transmitted from the order-entry/placement management support server 42, and transfers this in response to a requests from the order-entry/placement management system 50 of the affiliated company, and at the same time receives and records the invoice data transmitted from the process control servers 11, 21, and 31 of the subcontract companies A-C, and then transfers this in response to a request from the order-entry/placement management support server 42.

The order-entry/placement management support server 42 includes: a receiving-section 42a for receiving the encrypted invoice data; a decryption processing section 42b which carries out decryption processing to the encrypted invoice data; a recording section 42c which records the ordering data and the invoice data; a control form preparation section 42d which prepares the control form data indicative of the control form based on the ordering data and the invoice data recorded in the recording section 42c; a transmitting section 42e which transmits the ordering data and the invoice data to the order-entry/placement management system 50, and at the same time transmits the control form data to the WEB server 43; a control section 42f for controlling each part; an input section 42g including a keyboard, a mouse, and the like used for inputting various kinds of instructions and the like; and a display section 42h including a CRT or an LCD display.

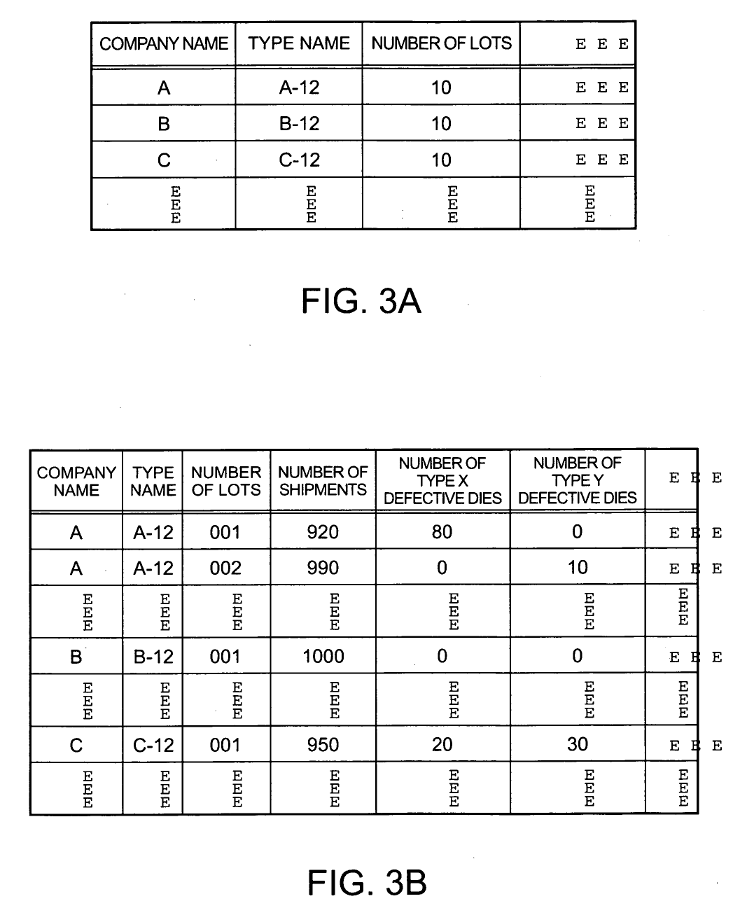

FIG. 3 is a view showing the contents of the ordering information and the invoice information used in this embodiment. As shown in FIG. 3A, an ordering information database (DB) recorded in the recording section 42 contains the information regarding the company names of the subcontract companies, the type name, the number of lots, and the like of the semiconductor device to be contracted out. Thereby because how many orders to have been placed to which subcontract companies can be grasped systematically, it is possible to support the order-entry/placement management work for the semiconductor device.

In FIG. 3A, it is shown that 10 lots of the type with a type name of “A-12” have been ordered to the wafer-processing process company A, which is expressed as a company name “A”, that 10 lots of the type with a type name of “B-12” have been ordered to the bump forming company B, which is expressed as a company name “B”, and that 10 lots of the type with a type name of “C-12” have been ordered to the probing-inspection company C, which is expressed as a company name “C”.

Moreover, an invoice information database (DB) recorded in the recording section 42c, as shown in FIG. 3B, contains the information regarding the company names of the subcontract companies, the type name and the lot number of the semiconductor devices to be contracted outside, the number of shipments, the number of defective goods, and the like. Thereby, because how many manufacturing processes have been completed in which subcontract companies can be grasped systematically, it is possible to support the order-entry/placement management work for the semiconductor device.

In FIG. 3B, it is shown that the wafer-processing process company A, which is expressed as a company name “A”, has completed the manufacturing process of the lots with the lot number of “001”, “002”, and so on of the type with a type name of “A-12”, that the bump forming company B, which is expressed as a company name “B”, has completed the manufacturing process of the lots with the lot number of “001” and so on of the type with a type name of “B-12”, and that the probing-inspection company C, which is expressed as a company name “C”, has completed the manufacturing process of the lots with the lot number of “001” and so on of the type with a type name of “C-12”.

Furthermore, the number of shipments and the number of defective goods in those subcontract companies are also shown. It is understood that in the wafer-processing process company A, the number of shipments of good dies are 920 chips, and the number of defective dies with a type X are 80 chips within the lot having a lot number “001”, the number of shipments of good dies are 990 chips and the number of defective dies with a type Y are 10 chips within the lot having a lot number “002”. Likewise, it is understood that in the bump formation company B, the number of shipments of good dies are 1,000 chips, and no defective dies exist within the lot having a lot number “001”, and that in the probing-inspection company C, the number of shipments of good dies are 950 chips, the number of defective dies with a type X are 20 chips, and the number of defective dies with a type Y are 30 chips within the lot having a lot number “001”.

Referring to FIG. 2, again, the control form preparation section 42d prepares a control form data file in a PDF format or the like, based on the ordering information database and the invoice information database, which are recorded in the recording section 42c. In addition, the control form contains the shipping information, a payment list, and a bonus & penalty.

The shipping information includes information, such as the timing when the semiconductor device (including a wafer or a chip) was shipped from each subcontract company, and the quantity thereof, and yields in each subcontract company. Moreover, the payment list includes the price per one lot or per one semiconductor wafer or per one chip, and the quantity at the time of placing the order, and the quantity as well as the lot number or the like of the manufactured semiconductor devices. The bonus & the penalty includes the increase/decrease of the price to be set based on the yields in each subcontract company, i.e., the premium to be set in the case of a high yield or the penalty to be set in the case of a low yield.

Upon preparation of the control form data file, a screen for transmitting the control form data file to the WEB server is displayed in the display section 42h. An operator, looking at the screen, designates the file to be transmitted using the input section 42g, and instructs the transmission, and thereby the transmitting section 42e transmits the control form data file to the WEB server 43. The transmitted control form data file is recorded in the WEB server 43, and thus the control form can be accessed from the order-entry/placement management support server 42 and the order-entry/placement management server 51 (FIG. 1) using a WEB browser or the like.

Again, referring to FIG. 1, the order-entry/placement management system 50 in the affiliated company is used for the management of the order entry/placement by recording the ordering data and the invoice data, and at the same time includes the order-entry/placement management server 51 which displays the control form using a WEB browser, and FW53 for preventing unauthorized accesses. Here, the order-entry/placement management server 51 is connected to the Internet 60 via a network N5 such as LAN, and FW53.

The order-entry/placement management server 51 receives and records an ordering data from the semiconductor maker's order-entry/placement management support server 42, and the processes each are entrusted to the wafer-processing process company A, the bump formation company B, and the probing-inspection company C, based on the ordering data. Even in the case of the integrated regional manufacture wherein these subcontract companies A-C exist in the same region, and the physical distribution moves directly between the subcontract companies A-C, the semiconductor maker's order-entry/placement management support system 40 receives the invoice data timely from the process control servers 11, 21, and 31 of the subcontract companies A-C, and transfers this invoice data to the order-entry/placement management server 51 of the affiliated company, whereby the controlling of the order entry/placement can be carried out promptly also in the affiliated companies.

Moreover, the order-entry/placement management server 51 receives a control form data file from the WEB server 43, and displays the control form using the WEB browser. Thereby, the time and effort for preparing the control form in the affiliated company can be saved. Moreover, in the semiconductor maker and the affiliated company, it is possible to manage the manufacturing of a semiconductor device using the same index.

### INDUSTRY APPLICABILITY

This invention can be utilized in the semiconductor-device order-entry/placement management support system for supporting the management of the order entry/placement to/from subcontract companies, in the case where the semiconductor device manufacturing company manufactures a semiconductor device by entrusting at least a part of the manufacturing processes in a series of manufacturing processes of the semiconductor device to at least one subcontract company.

What is claimed is:

1. A semiconductor-device order-entry/placement management support system for supporting the management of an order entry/placement in the case when a semiconductor device is manufactured by entrusting at least a part of the manufacturing processes in the manufacturing of a semiconductor device to at least one third company from a first company via a second company, comprising:
an order-entry/placement management server that is installed in the second company and receives an ordering information via a network;
a process-control server that is installed in the at least one third company and transmits an invoice information prepared based on the manufacturing results in an entrusted manufacturing process via a network; and
an order-entry/placement management support server that is installed in the first company, transmits an ordering information to the order-entry/placement management server via a network, transfers an invoice information received from the process control server to the order-entry/placement management server, and at the same time automatically prepares a document used for controlling the manufacturing of a semiconductor device based on the ordering information and the invoice information.

2. The semiconductor-device order-entry/placement management support system according to claim 1, further comprising a web server that is installed in the first company, automatically receives a document prepared by the order-entry/placement management support server, and publicizes this document to the second company using a web page of the Internet.

3. The semiconductor-device order-entry/placement management support system according to claim 1, wherein the ordering information includes a company name of the at least one third company, and an information indicative of a type name and a quantity of a semiconductor device manufactured or inspected in the at least one third company.

4. The semiconductor-device order-entry/placement management support system according to claim 1, wherein the invoice information includes an information indicative of a company name of the at least one third company, a type name and a lot number of a semiconductor device manufactured or inspected in the at least one third company.

5. The semiconductor-device order-entry/placement management support system according to claim 1, wherein the process control server encrypts and transmits the invoice information.

6. An order-entry/placement management support system for supporting the management of an order entry/placement in the case where a semiconductor device is manufactured by entrusting at least a part of the manufacturing processes in the manufacturing of a semiconductor device to at least one third company from a first company via a second company, comprising:
receiving means to receive an invoice information, which is prepared based on manufacturing results in a manufacturing process that is entrusted to the at least one third company, from a process control server installed in the at least one third company via a network;
transmitting means to transmit an ordering information to an order-entry/placement management server installed in the second company via a network, and to transfer an invoice information received by the receiving means to the order-entry/placement management server; and
documenting means to automatically prepare a document used for controlling the manufacturing of a semiconductor device based on the ordering information and the invoice information.

7. The order-entry/placement management support server according to claim 6, wherein the transmitting means transmits the document prepared by the documenting means to a web server, thereby publicizing this document to the second company using a web page of the Internet.

8. The order-entry/placement management support server according to claim 6, further comprising decrypting means to decrypt an encrypted invoice information that is transmitted from the process control server.
